(19) United States
(12) Patent Application Publication
(10) Pub. No.: US 2011/0320370 A1
(43) Pub. Date: Dec. 29, 2011

(54) System and Method for Providing Remote Representation

(76) Inventors: Alex Eduardo Henry, JR., Milpitas, CA (US); Calvin Spencer Weathington, Milpitas, CA (US)

(21) Appl. No.: 13/166,788

(22) Filed: Jun. 22, 2011

Related U.S. Application Data
(60) Provisional application No. 61/357,715, filed on Jun. 23, 2010.

(51) Int. Cl. G06Q 50/00; H04N 7/14; B60R 25/10

(52) U.S. Cl. 705/311; 340/426.18; 348/14.01; 348/E07.078

(57) ABSTRACT

The embodiments of the present invention provide novel systems and methods for providing on call real-time remote legal services by utilizing wireless audio and video components that also allow for two-way communication. The embodiments enable an individual to have access to legal representation and consult with legal counsel at the time an incident occurs.

### CROSS-REFERENCE TO RELATED APPLICATION

This application claims priority from U.S. Provisional Patent Application Ser. No. 61/357715, filed Jun. 23, 2010, which is incorporated herein by reference in its entirety for all purposes.

### FIELD OF THE INVENTION

The present invention relates to wireless communication, and more particularly to providing remote legal representation via video and audio equipment wirelessly.

### BACKGROUND

Protecting the rights of the driver and occupants of vehicles when in contact with law enforcement agencies is fundamental and important. There is a need to reduce the probability of citizens making the wrong choices or decisions during a traffic stop as citizens typically do not know their rights when being pulled over by law officials. Further it would be beneficial to reduce the likelihood of citizen complaints on law enforcement personnel, which cost taxpayer time and money to investigate and resolve. There is also a need to reduce injuries or death to clients and/or law enforcement personnel as well as reduce altercations between drivers when an accident occurs. Oftentimes the average individual lacks the funds to get appropriate education and training, hire legal assistance, and/or post bail which may result in added aggravation and unjust treatment.

Often times, an individual's reaction to contact with law enforcement may affect the response law enforcement has and the charges which the individual may face as a result of the contact. An individual may also not know how to respond to inquiries or know what his/her or their legal rights are. Further, it is not uncommon for an individual to become unusually uncomfortable or nervous when contacted by law enforcement or involved in an incident that may give rise to the involvement of law enforcement. Therefore, embodiments of the present invention provide novel systems and methods for providing legal services at the time of an incident such that the incident itself may at least in part be observed by legal counsel rather than relying on accounts of the incident after the fact.

### BRIEF SUMMARY

An embodiment of the present invention provides a method for an individual or company to obtain on-call legal representation. The method includes activating video and audio equipment, transmitting data from the video and audio equipment to a company which provides legal services, evaluating the transmitted data, advising activity based on the transmitted data, and continued monitoring of a situation in order to provide additional advice.

Another embodiment of the present invention provides a system for obtaining on-call legal representation. The system includes a video component, an audio component, a controller to direct the audio component and the video component, an electrical device to facilitate transmission of information between the audio component and the video component and a company providing legal services.

Other objects, advantages, and applications of the embodiments of the present invention will be made clear by the following detailed description of a preferred embodiment of the present invention. The description makes reference to drawings in which:

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of embodiments of the present invention, reference is made to the following Detailed Description, which is to be read in association with the accompanying drawings, wherein:

FIG. 1 illustrates a logical flow diagram generally showing one embodiment of a method for accessing remote audio and visual communication;

FIG. 2 illustrates a logical flow diagram generally showing one embodiment of a method for obtaining legal services as a result of one alternative action of the method of FIG. 1;

FIG. 3 illustrates a logical flow diagram generally showing one embodiment of a method for further access to remote audio and visual communication as a result of another alternative action of the method of FIG. 1;

FIG. 4 illustrates a logical flow diagram generally showing one embodiment of a method for obtaining legal services as a result of another alternative action of the method of FIG. 1;

FIG. 5 illustrates a logical flow diagram generally showing an embodiment of a method for obtaining real-time legal services at the time of a collision;

FIG. 6 illustrates a logical flow diagram showing an embodiment of a method for obtaining legal services in conjunction with reporting a vehicle theft;

FIG. 7 illustrates a vehicle configured with a wireless audio and video communication system in accordance with an embodiment of the present invention; and

FIG. 8 illustrates a vehicle configured with a wireless audio and video communication system in accordance with another embodiment of the present invention

### DETAILED DESCRIPTION OF PREFERRED EMBODIMENTS

The embodiments of the present invention are described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein. Rather, the disclosed embodiments are provided so that this disclosure will be thorough and complete, and will fully convey the scope of the invention to those skilled in the art. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.” The term “coupled” implies that the elements may be directly connected together or may be coupled through one or more intervening elements.

Briefly, embodiments of the present invention are directed to systems, and methods that facilitate communication with legal representation at the time of the activity or incident giving rise to the potential need for legal representation. The systems and methods include but are not limited to the enabling of oral and visual communication with legal representation via wireless communications. While embodiments of the present invention are described in conjunction with applications concerning legal representation in response to contact with law enforcement, it is equally applicable to any situation in which real-time communication of events or activities would be beneficial, such as but not limited to traffic stops, motor or recreational vehicle monitoring, and other personal safety situations as well as providing accident assistance after an accident has happened, i.e., assisting with the exchange of automobile insurance information and contacting law enforcement if needed.

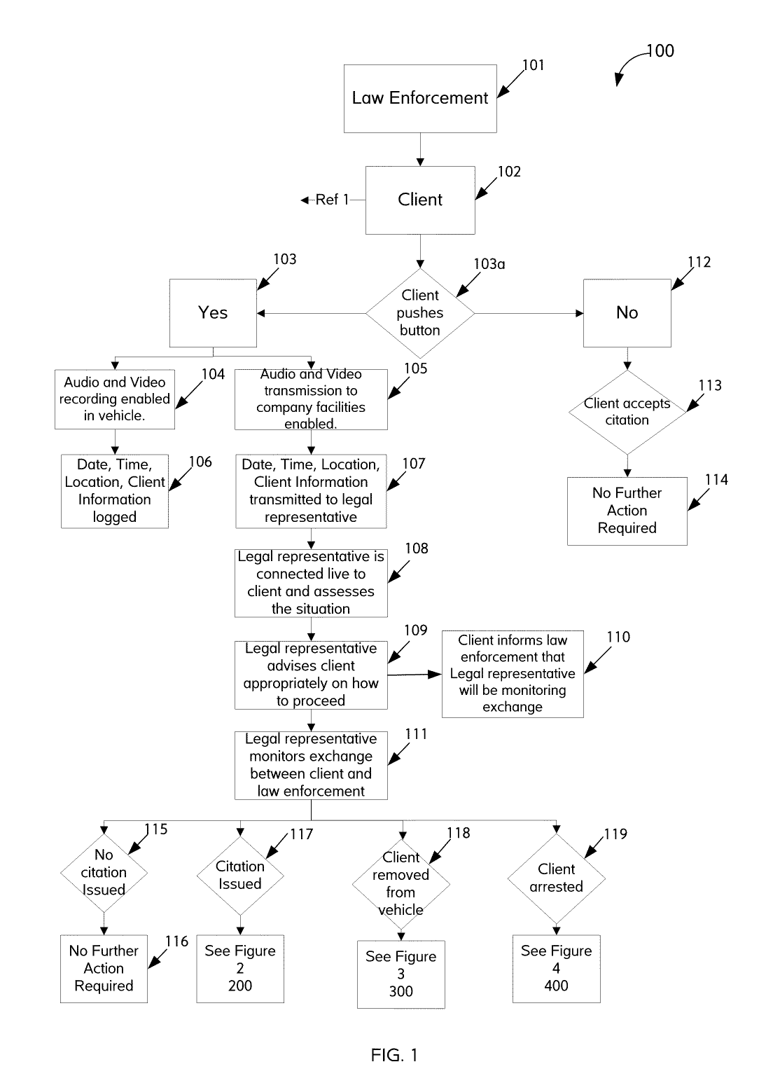

Turning now to the drawings, FIG. 1 is a block diagram of an exemplary method 100 for accessing wireless real time legal assistance while in or about a vehicle via video and audio equipment in accordance with an embodiment of the present invention. The method 100, begins with a client 102 having contact with law enforcement 101. The client 102, then presses a button 103 (YES, 1a) or other indicator 102a located on an electronic device to enable audio access and video recording 104 and transmission of the same to a company or other entity 105. In an alternative embodiment the service may be initiated by other means including but not limited to voice commands. In another alternative embodiment, the service may be initiated by remote means for example by key remote buttons or key fobs. In such an embodiment, a client stopped outside of vehicle or having an incident occurring outside a vehicle may activate the system remotely. Further, the client 102 may communicate over an open wireless protocol for exchanging data over short distances, for example, Bluetooth® technology.

The company or other entity may be the actual legal representative or an intermediary that provides access to legal services. The time, date and location are logged 106 and transmitted 107 to the company or other entity. A legal representative is connected live, if that format is operable, and is then able to assess the situation 108 and advise the client appropriately on how to proceed 109. In this instance the legal representative essentially provides on call services. The legal representative is connected live and observes via audio and video the interaction between the client and the law enforcement in real-time, meaning as it is happening. If the legal representative is connected live, the client will have previously entered into a contract for legal services so that all available protections are available. The contract for legal services may be limited in scope or expansive and may be tailored to meet the needs of individual client. For example the scope could be limited to providing remote advice, could include legal representation in court, strategic counseling, bonding or any alternatives or combinations depending on the terms and costs the client is willing to incur. In some instances, the client may inform the law enforcement representative that a legal representative will be monitoring exchange. Whether the decision is made to inform law enforcement or not, the legal representative is able to and does monitor the exchange between the client 102 and law enforcement 101.

In an alternate embodiment, the client 102 despite having contact with law enforcement 101 and access to the device and legal counsel, decides not to access the services (112 No) 1b and the method ends. In this instance, the client may be issued a citation and accept it 113, requiring no further action 114. Alternatively, the client could accept the citation 113 and then later seek legal counsel (not shown). However in this instance, the client may be disadvantaged by not having utilized the live real-time services of the legal representative.

As a result of the interaction between law enforcement 101 and the client 102, various different events may occur. In one embodiment, no citation is issued 115, and no further action is required 116.

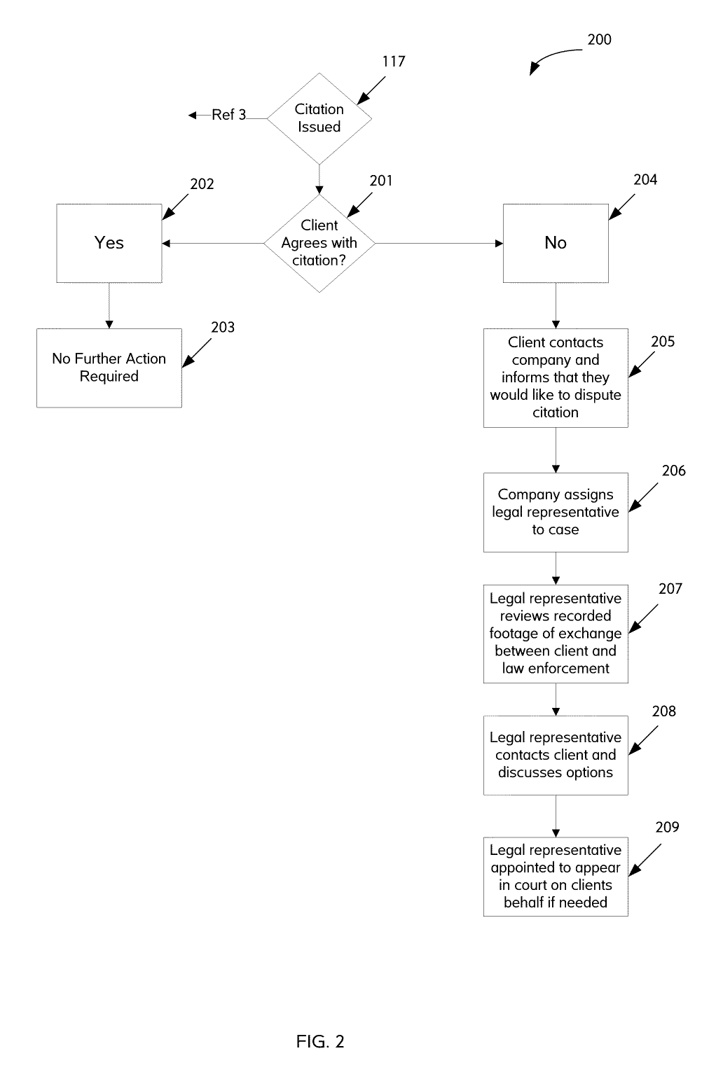

In an alternate embodiment, a citation is issued 117, and the client 102 is release on his own recognizance (i.e., as in the case of a traffic infraction) and the client 102 reacts to the citation as depicted in FIG. 2. FIG. 2 is a block diagram illustrating the response flow 200 as a result of the citation 117 of FIG. 1. The client 102, client has the choice of agreeing with or disagreeing with citation 201. If the client 102 agrees with citation or decides to otherwise accept the citation (Yes 202), no further action required 203. Alternatively, if the client disagrees with citation (No 204), the client 102 contacts the company, which observed the interaction in FIG. 1 and informs it that he would like to dispute the citation 205. The company assigns a legal representative to the case 206. Alternatively, the case may have been automatically assigned to a legal representative after the audio and video transmission was complete. In this latter instance, no action is taken until the company is contacted by the client 102, but there is already an assigned legal representative. The legal representative reviews recorded audio and video footage 207 of the exchange between client 102 and law enforcement 101. The legal representative may then make contact with the client 102 and discuss the client's options in response to what transpired 208. The legal representative may merely provide advice or may be appointed to appear in court on client's behalf if necessary 209.

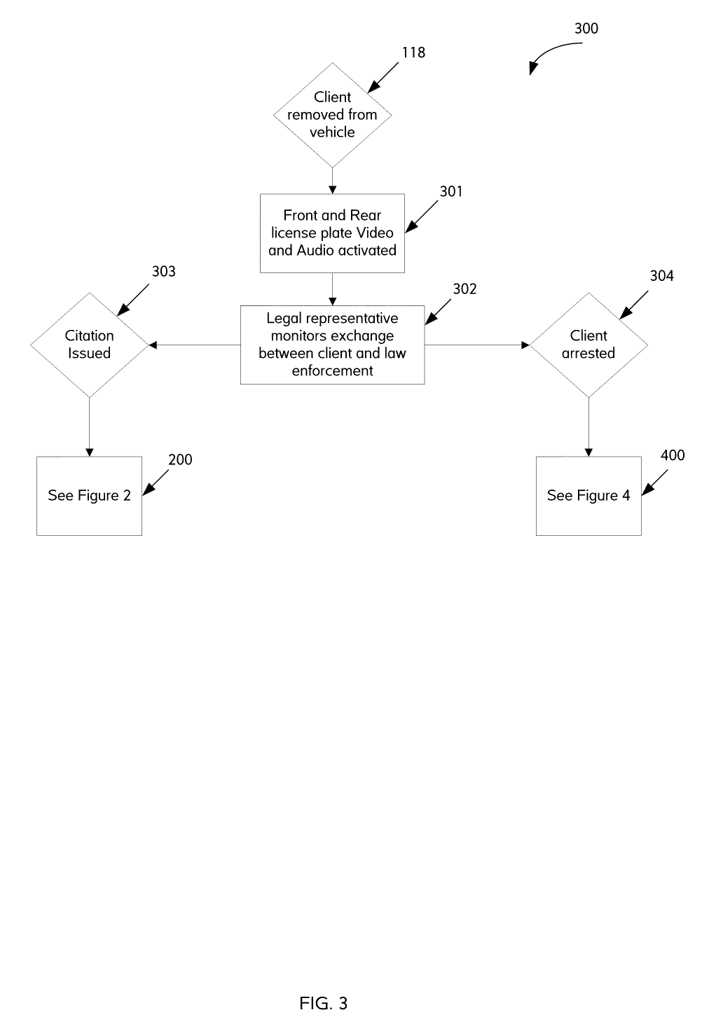

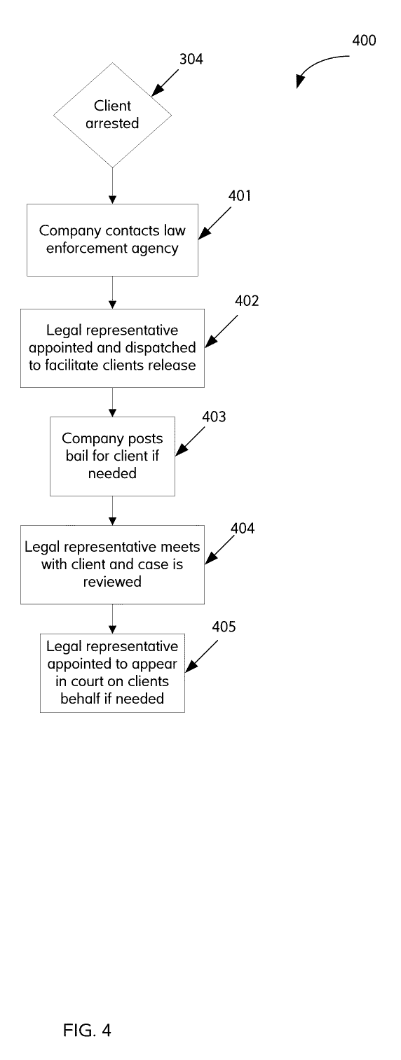

In another embodiment, the client 102 is removed from his vehicle 118. FIG. 3 is a block diagram illustrating the response flow 300 as a result of the client 102 being removed from the vehicle 118 as illustrated in FIG. 1. If the client 102 is removed from the vehicle 118, front and rear license video and audio are enabled 301. The front and rear license audio and video may be enabled on the client side by the client 102 depressing a button, using voice controls or otherwise activating the system. In another embodiment the front and rear license audio and video may be automatically activated based on weight sensors or other sensing mechanisms which monitor the client's movement. In another embodiment, the front and rear license audio and video may be activated by an action taken on the company side. The system may be activated by the client prior to being removed from the vehicle, may be activated when the client exits the vehicle, or may be activated after the vehicle has been exited. Neither the timing of activation nor order of events is intended to be a limitation on the embodiments of the present invention. While referred to as front and rear audio and video, it is contemplated within the scope of the embodiments of the present invention that the video could also in addition or in the alternative be located in other areas of the vehicle. Once the audio and video is enabled, the legal representative continues to monitor exchange between client and law enforcement 302. If a citation is issued 303, (or no citation is issued (not shown)) the method then proceeds as described above in conjunction with FIG. 2. Alternatively, if the contact in FIG. 3 results in the client 102 being arrested 304, the method proceeds as described in conjunction with FIG. 4 below

If the client 102 is arrested 304 the method proceeds as depicted in the block diagram of FIG. 4. FIG. 4 depicts one embodiment of the process 400 that may occur after the client 102 is arrested 304. After the client is arrested 304, the legal representative or other person from the company contacts the arresting law enforcement agency 401 to locate client 102. The legal representative is appointed and may be dispatched to facilitate the client's release 402. Coordinating the client's release may optionally necessitate contact with other parties including but not limited to bonding companies, friends, and relatives. In one embodiment the company itself posts bail for client 403. The legal representative meets with client 102, in person or through other communication means and reviews the case as well as defenses and strategy 404 with the client 102. The legal representative continues as the client's representative and may be appointed to appear in court on clients' behalf if needed 405, provide other support or referral as necessary after evaluation of the case.

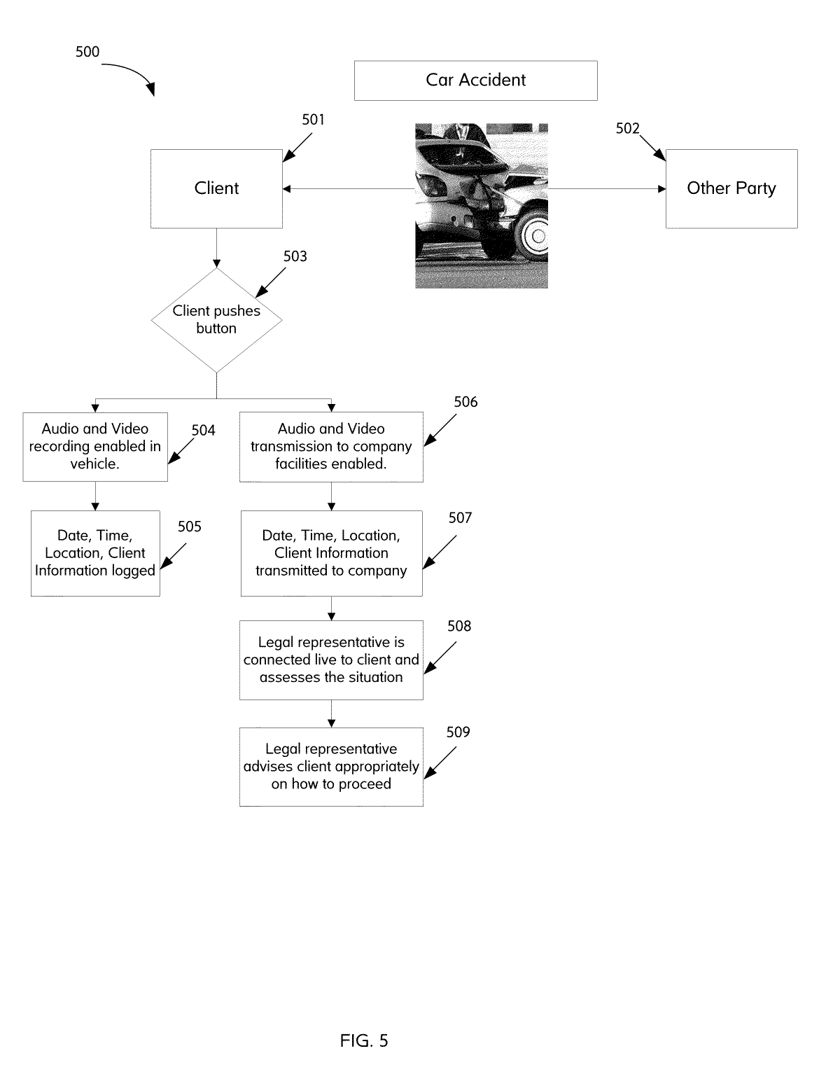

FIG. 5 is a block diagram of an exemplary method 500 for accessing wireless real time legal assistance for an automobile accident via video and audio equipment in accordance with an embodiment of the present invention. After an accident between a client 501 and another party 502 occurs, the client 501 pushes button or other otherwise activates the wireless system 503. Once the system is activated, audio and video recording and transmission are enabled 506. The time, date and location are logged 505 and are transmitted to the company 507. The legal representative is connected live in real-time and assesses the situation 508. The legal representative may then advise the client appropriately on how to proceed 509.

In an alternate embodiment, the wireless system is constantly on and activated such that all activity is constantly being monitored. In such an alternate embodiment, the system may contain a memory means to store the data obtained as opposed to requiring constant live monitoring. In this “constant on” embodiment, the client optionally transitions to real-time monitoring after the occurrence of an accident.

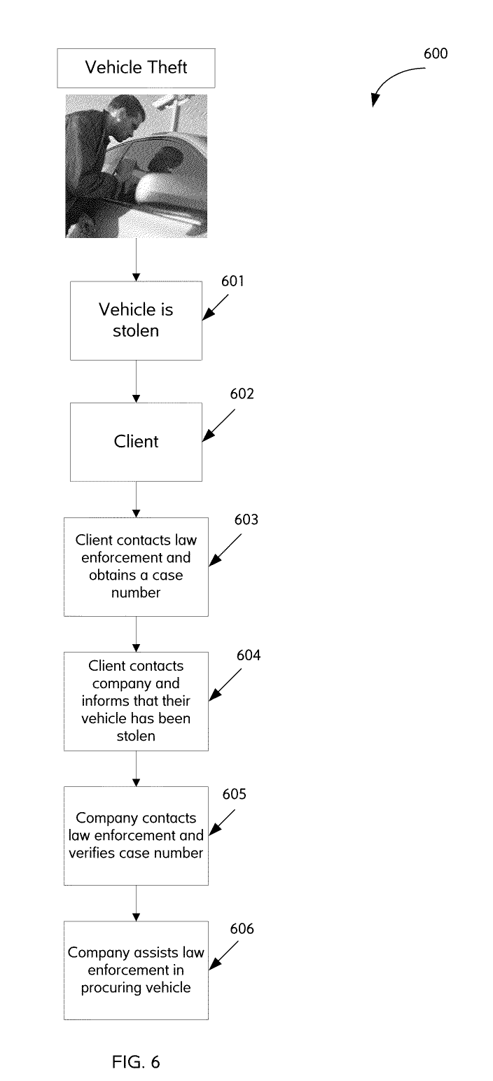

FIG. 6 is a block diagram of an exemplary method 600 for accessing wireless real time legal assistance for an automobile theft via video and audio equipment in accordance with an embodiment of the present invention. After a theft occurs 601, the client 602 contacts law enforcement agency and obtains a case number 603. The client then contacts company and informs the company that his/her or its vehicle has been stolen 604. The company then contacts law enforcement agency and verifies case number 605. The company assists law enforcement in procuring vehicle by remotely enabling audio and video recording and transmission with date, time and location for the stolen vehicle 606.

In an alternate embodiment, the wireless system is constantly on and activated such that all activity is constantly being monitored and the theft of the vehicle itself would be recorded. In such an alternate embodiment, the system may contain a wireless communication means linked to remote data storage to store the data obtained while monitoring the vehicle as opposed to requiring constant live monitoring. The client may activate the system upon parking and leaving the vehicle. In such an embodiment, the company may optionally monitor changes in the vehicle position and/or access. Further, the system may include tracking means and other theft deterrent and recovery means.

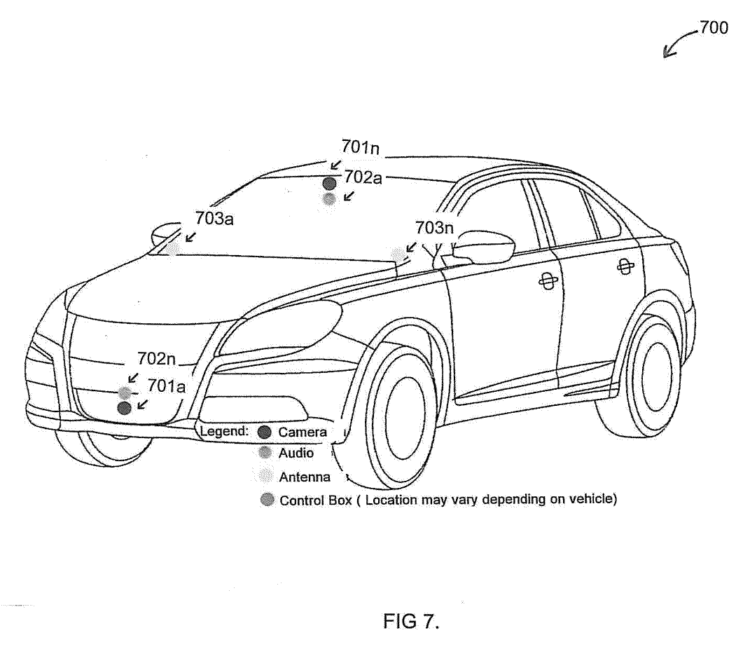

FIG. 7 depicts a hardware diagram of a vehicle 700 configured with the wireless audio and video system in accordance with one embodiment of the present invention. The system is comprised of video components 701 (a . . . n) to capture images and the like of the event or occurrence, audio component 702 (a . . . n) to capture the sounds, communications, noises and the like of the event or occurrence, electrical devices 703 (a . . . n) which couple radio waves or the like in free space to an electrical current for example an antenna to facilitate transmission of information between the various components and the company, and a control box for operating all of the components. Although the present embodiment is depicted with two audio, two video and two antenna devices such is not intend to be a limitation on the embodiments and a lesser or greater number of devices may be implemented. 701 (a . . . n) indicates possible locations for visual devices such as cameras, video recorders, and the like. 702 (a . . . n) indicates possible locations of audio devices, such as audio recorders. It is contemplated within the scope of the embodiments of the present invention that the audio and video components may be combined in a single device. 703(a . . . n) indicates possible locations for antennas, configured to provide a signal to the company and transmit the collected information and data. A control box may be located as appropriate on the vehicle. The location is not critical as the control box communicates with the other electronic components but is not required to be positioned in a particular location in order to optimize its operation.

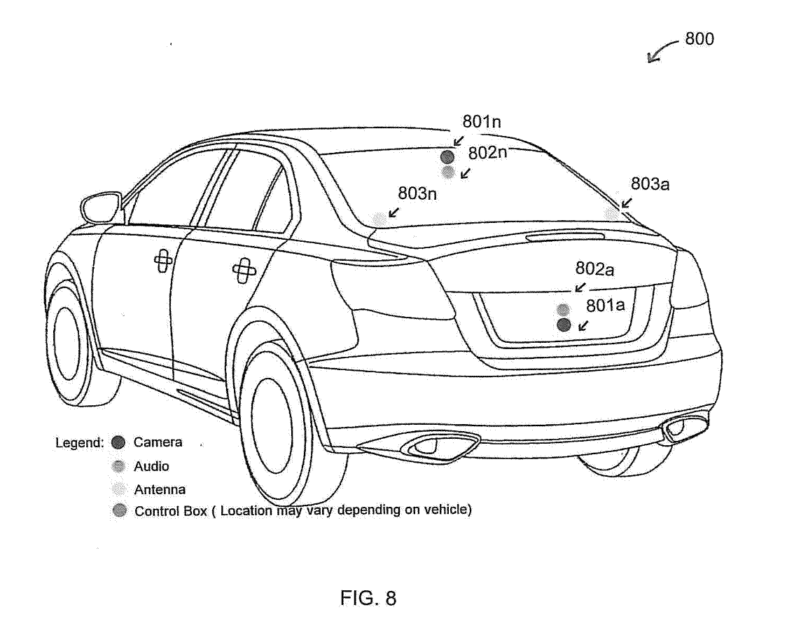

FIG. 8 depicts a hardware diagram of a vehicle 800 configured with the wireless audio and video system in accordance with one embodiment of the present invention. The system is comprised of video components to capture images and the like of the event or occurrence, audio component to capture the sounds, communications, noises and the like of the event or occurrence, electrical devices which couples radio waves or the like in free space to an electrical current for example an antenna to facilitate transmission of information between the various components and the company and a control box for operating all of the components. 801 (a . . . n) indicates possible locations for visual devices such as cameras, video recorders, and the like. 802 (a . . . n) indicates possible locations of audio devices, such as audio recorders. It is contemplated within the scope of the embodiments of the present invention that the audio and video components may be combined in a single device. 803 (a . . . n) indicates possible locations for antennas, configured to provide a signal to the company and transmit the collected information and data. A control box may be located as appropriate on the vehicle. The location is not critical as the control box communicates with the other electronic components but is not required to be positioned in a particular location in order to optimize its operation.

In a preferred embodiment, the relationship among elements, including preferred logical and flow order is as shown in the exemplary embodiments. However, such embodiments are not intended to be a limitation on the scope of the embodiments of the present invention and other arrangements are contemplated within the scope.

In another preferred embodiment, the process preferably begins with the contact between law enforcement 101 and the client 102 FIG. 1 and ends at no citation issued resulting in no further required action 116. As shown in FIG. 1, the method preferably occurs before the client pushes the access button 102a, which preferably occurs before the no citation is issued 115, and so forth. However, the order of many of these steps may be changed. By way of example but not limitation, the step of the client 102 being arrested 119 may occur before the step of citation issued 117.

In yet another example, the flowchart shown represents a process that is performed by the client. However, the client may not execute the steps or decisions in the manner shown. For example, the client in the step of client pushes button 103 (Yes) could inform law enforcement that exchange is being monitored without having pushed the button.

In another embodiment the method proceeds as follows. When a client is pulled over in the method 100 he/she will have the choice to push the button 102a, steps 103, 112. If client pushes button he then executes the steps of client pushes button (Yes) 103. Subsequently to this step, if the client does not push the button 112, then no further action is required.

If the client pushes the button 103, then audio, video recording and transmission will be enabled. The client will then be connected to a legal representative, who will monitor and advise client appropriately throughout exchange with law enforcement.

The invention would be used to provide the client with legal advice during a traffic stop by monitoring the exchange with law enforcement. The system may also be used in the event of an emergency such as an accident, or the need of medical attention. Although described in conjunction with obtaining real-time or on-call legal services, the systems and methods described herein are equally applicable to providing other real-time on call services that may benefit from audio and video communications including but not limited to emergency medical services, and managing customer relations.

In another embodiment, a mobile phone or smart phone with video chat ability may be implemented in this method. When implemented using such a device, legal services could be provided even when the user is located away from the vehicle. The system and method provided herein may be used by individuals as well as businesses, for example, insurance companies, companies which manage fleets such as taxis, trucking companies, limousine services and the like as well as law enforcement agencies could use this invention.

In other embodiments, a desktop computer, laptop, tablet or any microprocessor based device or CPU/PCU based device may be implemented.

The embodiments herein have been described as wireless. This description is provided for in its broadest sense and is intended to cover all present and future technologies which enable the transfer of information over short distances or long distances including but not limited to utilizing internet connections, cellular or satellite technology.

In further non-limiting examples, embodiments of the present invention may be implemented on airlines, in public or private transportation means such as limousines or buses, on boats, in public or private schools, at public or private recreational facilities, in public or private parking structures and in public or private buildings or other facilities

Further the method can produce evidence and data that may be used by various persons and entities including law enforcement, private investigators, private counsel, or by other agencies.

As noted previously the forgoing descriptions of the specific embodiments are presented for purposes of illustration and description. They are not intended to be exhaustive or to limit the invention to the precise forms disclosed and obviously many modifications and variations are possible in view of the above teachings, including equivalents. The embodiments were chosen and described in order to explain the principles of the invention and its practical applications, to thereby enable those skilled in the art to best utilize the invention and various embodiments thereof as suited to the particular use contemplated. It is intended that the scope of the invention be defined by the claims, including such changes and modifications and their equivalents.

What is claimed is:

1. A method for providing legal representation comprising:
activating video and audio equipment;
transmitting data from the video and audio equipment to a company providing legal services;
evaluating the transmitted data;
advising a user on how to proceed based on the transmitted data; and
monitoring the user's actions.

2. The method of claim 1, wherein the company provides legal services.

3. The method of claim 1, wherein the company provides medical services.

4. The method of claim 2, further comprising providing additional advice concurrent with or after monitoring the client's actions.

5. The method of claim 1, wherein transmitting data is performed in real-time

6. The method of claim 2, wherein activating the video and audio equipment is performed in response to contact by law enforcement.

7. The method of claim 6, further comprising providing legal advice after law enforcement has taken an action.

8. The method of claim 7, wherein the law enforcement action is an arrest.

9. The method of claim 1, wherein activating the video and audio equipment is performed in response to a collision.

10. The method of claim 1, wherein activating the video and audio equipment is done remotely.

11. The method of claim 1, wherein activating audio and video equipment is performed by the user.

12. A method for assisting in recovery of a stolen vehicle comprising:
reporting a vehicle having installed audio and video equipment missing to a law enforcement agency;
transmitting the missing vehicle information to a company;
remotely activating the video and audio equipment;
transmitting data from the video and audio equipment to the company; and
evaluating the transmitted data to assist in locating the missing vehicle.

13. A system for providing on call services comprising:
at least one video component to capture images;
at least one audio component to capture the sound;
at least one controller to direct the at least one audio component and the at least one video component;
at least one electrical device to facilitate transmission of information between the at least one audio component and the at least one video component and a company providing services.

14. The system of claim 13, wherein the audio and video components are a smartphone.

15. The system of claim 13, wherein the company providing services provides legal services.

16. The system of claim 13, wherein the audio and video components are installed in a vehicle.

17. The system of claim 13, wherein the audio and video components are installed in a facility.
